(19) United States
(12) Patent Application Publication
(10) Pub. No.: US 2024/0243438 A1
(43) Pub. Date: Jul. 18, 2024

(54) OPTIMIZED ELECTRODE INTERFACIAL AREAS FOR ALKALINE BATTERIES

(71) Applicant: Energizer Brands, LLC, St. Louis, MO (US)

(72) Inventors: Guanghong Zheng, Westlake, OH (US); Xiaotong Chadderdon, Westlake, OH (US)

(73) Assignee: Energizer Brands, LLC, St. Louis, MO (US)

(21) Appl. No.: 18/156,178

(22) Filed: Jan. 18, 2023

(51) Int. Cl. H01M 50/489; H01M 10/28

(52) U.S. Cl. CPC H01M 50/489; H01M 10/286

(57) ABSTRACT

Electrochemical cells are provided. An example electrochemical cell may include a container, an electrolyte; an anode; a cathode; a current collector, and a separator disposed between the anode and the cathode. In some embodiments, the anode and the cathode may define an interfacial area y and the separator defines a thickness x, wherein a relation between the interfacial area y and the separator thickness x is defined between 26.532x^{-0.15}≤y≤284.5x^{-0.675}.

The present disclosure relates generally to alkaline batteries, and more particularly to optimizing the interfacial area between electrodes in alkaline batteries.

### BACKGROUND

Alkaline battery performance (e.g., run-time) differs depending on whether the battery is being used in a low-rate (e.g., low current draw) application or a high-rate (e.g., high current draw) application. For low-rate applications, the active material within anodes and cathodes of alkaline cells have been observed to have a relatively high depth of discharge (i.e., a large volume of active material discharges, even at a relatively large distance away from the interfacial area between the anode and cathode). However, alkaline battery run-time for high-rate discharge applications is dependent on the interfacial area between an anode and cathode within the electrochemical cell. Also, the anode and cathode within an alkaline electrochemical cell must be electrically separated by a separator having a non-negligible thickness to avoid short-circuits. Therefore, increasing the interfacial area between the anode and the cathode proportionally increases the separator volume within the electrochemical cell. Because alkaline electrochemical cells are typically limited to industry-standardized cell sizes (e.g., LR6, LR03, etc.) the amount of active material added to the cell must be decreased to accommodate any increases in separator volume. Thus, adjusting an alkaline electrochemical cell design to maximize high-rate performance (e.g., run-time) can decrease low-rate performance (e.g., run-time) at least in part due to the decrease in active material that results from increasing the interfacial area and consequently increasing the volume of separator material in the cell. This impact in low-rate performance can be mitigated by using a thinner separator material (which occupies less volume), however thinner separators may be subject to issues with structural integrity, including the possibility of punctures during manufacturing of the electrochemical cell and internal short during discharge.

Practically, consumers use the same electrochemical cells in both high-rate and low-rate applications. Hence, a need exists to optimize the interfacial area to achieve performance optimization for both high-rate and low-rate discharge for alkaline batteries.

### BRIEF SUMMARY

In general, embodiments of the present disclosure provide electrochemical cells, and/or the like.

According to various embodiments, there is provided an electrochemical cell including a container; an electrolyte; an anode; a cathode; a current collector; and a separator disposed between the anode and the cathode, wherein the anode and the cathode define an interfacial area y and the separator defines a thickness x, and wherein a relation between the interfacial area y and the separator thickness x is defined between 26.532x^{-0.15}≤y≤284.5x^{-0.675}.

In some embodiments, the relation between the interfacial area y and the separator thickness x is defined between 32.432x^{-0.193}≤y≤224.73x^{-0.63}.

In some embodiments, the relation between the interfacial area y and the separator thickness x is defined between 39.195x^{-0.232}≤y≤183.08x^{-0.592}.

According to various embodiments, there is provided an electrochemical cell including a container; an electrolyte; an anode; a cathode; a current collector; and a separator disposed between the anode and the cathode, wherein the anode and the cathode define an interfacial area and the separator defines a thickness, and wherein the separator thickness is selected from a either a first group ranging between 0.1 mil and 1 mil, a second group ranging between 1 mil and 5 mil, a third group ranging between 5 mil and 10 mil, and a fourth group ranging between 10 mil and 18 mil.

In some embodiments, the separator thickness is selected from the first group ranging between 0.1 mil and 1 mil, and the interfacial area is selected from a group ranging between 27 and 1346 cm².

In some embodiments, the separator thickness is selected from the first group ranging between 0.1 mil and 1 mil, and the interfacial area is selected from a group ranging between 32 and 959 cm².

In some embodiments, the separator thickness is selected from the first group ranging between 0.1 mil and 1 mil, and the interfacial area is selected from a group ranging between 39 and 716 cm².

In some embodiments, the separator thickness is selected from the second group ranging between 1 mil and 5 mil, and the interfacial area is selected from a group ranging between 21 and 285 cm².

In some embodiments, the separator thickness is selected from the second group ranging between 1 mil and 5 mil, and the interfacial area is selected from a group ranging between 24 and 225 cm².

In some embodiments, the separator thickness is selected from the second group ranging between 1 mil and 5 mil, and the interfacial area is selected from a group ranging between 27 and 183 cm².

In some embodiments, the separator thickness is selected from the third group ranging between 5 mil and 10 mil, and the interfacial area is selected from a group ranging between 19 and 96 cm².

In some embodiments, the separator thickness is selected from the third group ranging between 5 mil and 10 mil, and the interfacial area is selected from a group ranging between 21 and 82 cm².

In some embodiments, the separator thickness is selected from the third group ranging between 5 mil and 10 mil, and the interfacial area is selected from a group ranging between 23 and 71 cm².

In some embodiments, the separator thickness is selected from the fourth group ranging between 10 mil and 18 mil, and the interfacial area is selected from a group ranging between 17 and 60 cm².

In some embodiments, the separator thickness is selected from the fourth group ranging between 10 mil and 18 mil, and the interfacial area is selected from a group ranging between 19 and 53 cm².

In some embodiments, the separator thickness is selected from the fourth group ranging between 10 mil and 18 mil, and the interfacial area is selected from a group ranging between 20 and 47 cm².

According to various embodiments, there is provided an electrochemical cell including a container; an electrolyte; an anode; a cathode; a current collector; and a separator disposed between the anode and the cathode, wherein the anode and the cathode define an interfacial area, wherein the interfacial area is selected such that the electrochemical cell has an average ANSI performance within 8% of a maximum theoretical performance of the electrochemical cell, wherein the maximum theoretical performance defined by z=0.1191x²−4.9119x+178.16 is achieved by a theoretical electrochemical cell having an interfacial area defined according to the formula y=86.697x^{-0.423}.

In some embodiments, the electrochemical cell has an average ANSI performance within 5% of the maximum theoretical performance of the electrochemical cell.

In some embodiments, the electrochemical cell has an average ANSI performance within 3% of the maximum theoretical performance of the electrochemical cell.

The above summary is provided merely for purposes of summarizing some example aspects to provide a basic understanding of some aspects of the disclosure. Accordingly, it will be appreciated that the above-described aspects are merely examples. It will be appreciated that the scope of the disclosure encompasses many potential aspects in addition to those here summarized, some of which will be further described below.

### BRIEF SUMMARY OF THE DRAWINGS

Having thus described the disclosure in general terms, reference will now be made to the accompanying drawings, which are not necessarily drawn to scale, and wherein:

FIG. 1 is a side, cross-sectional, elevational view of an example electrochemical cell design in accordance with some embodiments;

FIGS. 2A and 2B are radial, cross-sectional views of example jellyroll electrode assemblies, with FIG. 2A showing a cathode outer wrap design and FIG. 2B showing an anode outer wrap design, in accordance with some embodiments;

FIG. 3 illustrates a discharge profile for an example electrochemical cell in accordance with some embodiments;

FIGS. 4, 5, 6, and 7 graphically illustrate relationships between run times, active material input, and discharge efficiency versus interfacial area between electrodes in an alkaline cell in accordance with some embodiments;

FIG. 8 illustrates electrochemical cell performance measured against interfacial area in accordance with some embodiments;

FIG. 9 illustrates electrochemical cell performance and optimized interfacial area in accordance with some embodiments; and

FIGS. 10, 11, and 12 illustrate maximum performance and optimized interfacial area for various electrochemical cells measured by interfacial area and separator thickness in accordance with some embodiments.

### DETAILED DESCRIPTION AND DISCUSSION

Various embodiments now will be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item. For example, “an organic additive” may refer to two or more organic additives.

To the extent they are not explicitly mutually inconsistent, each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths, hundredths, thousandths, ten-thousandths, and hundred-thousandths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 7-10%, 5.1%-9.9%, and 5.01%-9.99%. As another example, “0.00001-1 M” includes 0.00005-0.0001 M and 0.001-0.01 M.

As used herein, “about” in the context of a numerical value or range means within ±10% of the numerical value or range recited or claimed.

As used herein, “run-time” refers to the length of time that an electrochemical cell will be able to provide a certain level of charge.

Unless otherwise specified, as used herein the terms listed below are defined and used throughout this disclosure as follows:

Ambient temperature or room temperature-between about 20° C. and about 25° C. Unless otherwise stated, all examples, data and other performance and manufacturing information were conducted at ambient temperature and under normal atmospheric conditions.

Anode—the negative electrode, to serve as the primary electrochemically active material, with an example main active material being Zinc.

Capacity—the capacity delivered by a single electrode or an entire cell during discharge at a specified set of conditions (e.g., drain rate, temperature, etc.); typically expressed in milliamp-hours (mAh) or milliwatt-hours (mWh) or by the number of minutes or images taken on the digital still camera (DSC) test. As discussed herein, Capacity may be expressed and/or measured for low-rate discharge or high-rate discharge.

Cathode—the positive electrode; in some embodiments, the active material of cathode may be manganese dioxide (MnO₂), such as electrolytic manganese dioxide (EMD).

Cell housing—the structure that physically encloses the electrode assembly (e.g., the anode, cathode, separator, and current collector(s)). The cell housing comprises all internally enclosed safety devices, inert components and connecting materials which comprise a fully functioning battery; typically these will include a container (formed in the shape of a cup, also referred to as a “can” or a “receptacle”) and a closure (fitting over the opening of the container and normally including venting and sealing mechanisms for impeding electrolyte egress and moisture/atmospheric ingress); depending upon the context may sometimes be used interchangeably with the terms can or container.

Cylindrical cell size—any cell housing having a circular-shaped cylinder with a height that is greater than its diameter;

Electrochemically active material—one or more chemical compounds that are part of the discharge reaction of a cell and contribute to the cell discharge capacity, but including impurities and small amounts of other moieties inherent to the material;

LR6 or AA-sized cell—With reference to International Standard IEC-60086-1 published by the International Electrotechnical Commission after November 2000, a cylindrical cell size zinc-manganese dioxide (Zn—MnO₂) battery with a maximum external height of about 50.5 mm and a maximum external diameter of about 14.5 mm;

LR03 or AAA-sized cell—With reference to International Standard IEC-60086-1 published by the International Electrotechnical Commission after November 2000, a cylindrical cell size zinc-manganese dioxide (Zn—MnO₂) battery with a maximum external height of about 44.5 mm and a maximum external diameter of about 10.5 mm;

Interfacial area—surface area between the anode and the cathode;

“Jellyroll” (or “spirally wound”) electrode assembly-strips of anode and cathode, along with an appropriate separator, are combined into an assembly by winding along their lengths or widths, e.g., around a mandrel or central core;

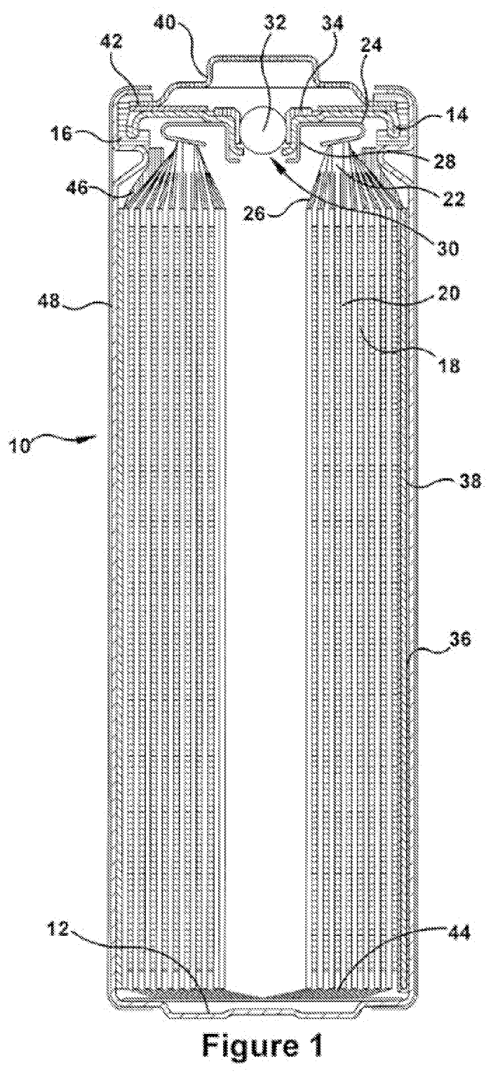

In FIG. 1, a cell 10 is shown as one embodiment of a LR6 (AA) type cylindrical Zn—MnO₂ battery cell, although this disclosure applies similarly to LR03 (AAA) or other cylindrical cells. The cell 10 has, in one embodiment, a housing that includes a container in the form of a can 12 with a closed bottom and an open top end that is closed with a cell cover 14 and a gasket 16. The can 12 has a bead or reduced diameter step near the top end to support the gasket 16 and cover 14. The gasket 16 is compressed between the can 12 and the cover 14 to seal an anode or negative electrode 18, a cathode or positive electrode 20, and electrolyte within the cell 10.

The anode 18, cathode 20 and a separator 26 are spirally wound together into an electrode assembly. The cathode 20 has a metal current collector 22, which extends from the top end of the electrode assembly and is connected to the inner surface of the cover 14 with a contact spring 24. The anode 18 is electrically connected to the inner surface of the can 12 by a metal lead (or tab) 36. The lead 36 is fastened to the anode 18, extends from the bottom of the electrode assembly, and is folded across the bottom and up along the side of the electrode assembly. The lead 36 makes pressure contact with the inner surface of the side wall of the can 12. It should be understood that this configuration is merely an example, and in other embodiments, the cathode may be in electrical contact with the can, and the anode may be in electrical contact with the cover. In such embodiments, the physical structure of the can and cover may vary (e.g., such that the positive-terminal pip shown as integrated with the cover may be integrated with the can, and the cover may have a generally flat configuration). After the electrode assembly is wound, it can be held together before insertion by tooling in the manufacturing process, or the outer end of material (e.g., separator or polymer film outer wrap 38) can be fastened down by heat sealing, gluing or taping, for example.

In the illustrated embodiment, an insulating cone 46 is located around the peripheral portion of the top of the electrode assembly to prevent the cathode current collector 22 from contacting the can 12, and contact between the bottom edge of the cathode 20 and the bottom of the can 12 is prevented by the inward-folded extension of the separator 26 and an electrically insulating bottom disc 44 positioned in the bottom of the can 12.

In one embodiment, the cell 10 has a separate positive terminal cover 40, which is held in place by the inwardly crimped top edge of the can 12 and the gasket 16 and has one or more vent apertures (not shown). The can 12 serves as the negative contact terminal. An insulating jacket, such as an adhesive label 48, can be applied to the side wall of the can 12.

In one embodiment, disposed between the peripheral flange of the terminal cover 40 and the cell cover 14 is a positive temperature coefficient (PTC) device 42 that substantially limits the flow of current under abusive electrical conditions. In another embodiment, the cell 10 may also include a pressure relief vent. The cell cover 14 has an aperture comprising an inward projecting central vent well 28 with a vent hole 30 in the bottom of the well 28. The aperture is sealed by a vent ball 32 and a thin-walled thermoplastic bushing 34, which is compressed between the vertical wall of the vent well 28 and the periphery of the vent ball 32. When the cell internal pressure exceeds a predetermined level, the vent ball 32, or both the ball 32 and bushing 34, is forced out of the aperture to release pressurized gases from the cell 10. In other embodiments, the pressure relief vent can be an aperture closed by a rupture membrane, such as disclosed in U.S. Patent Application Publication Nos. 20050244706 and 20080213651, which are incorporated herein by reference in their entirety, or a relatively thin area such as a coined groove, that can tear or otherwise break, to form a vent aperture in a portion of the cell, such as a sealing plate or container wall.

In one embodiment, the terminal portion of the electrode lead 36, disposed between the side of the electrode assembly and the side wall of the can, may have a shape prior to insertion of the electrode assembly into the can, preferably non-planar, that enhances electrical contact with the side wall of the can and provides a spring-like force to bias the lead against the can side wall. During cell manufacture, the shaped terminal portion of the lead can be deformed, e.g., toward the side of the electrode assembly, to facilitate its insertion into the can, following which the terminal portion of the lead can spring partially back toward its initially non-planar shape, but remain at least partially compressed to apply a force to the inside surface of the side wall of the can, thereby making good physical and electrical contact with the can. Alternatively, this connection, and/or others within the cell, may also be maintained by way of welding.

The cell container may in some embodiments be a metal can with a closed bottom such as the can in FIG. 1. The can material and thickness of the container wall will depend in part of the active materials and electrolyte used in the cell. A common material type is steel. For example, the can may be made of cold rolled steel (CRS), and may be plated with nickel on at least the outside to protect the outside of the can from corrosion. The type of plating can be varied to provide varying degrees of corrosion resistance, to improve the contact resistance or to provide the desired appearance. The type of steel will depend in part on the manner in which the container is formed. For drawn cans, the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

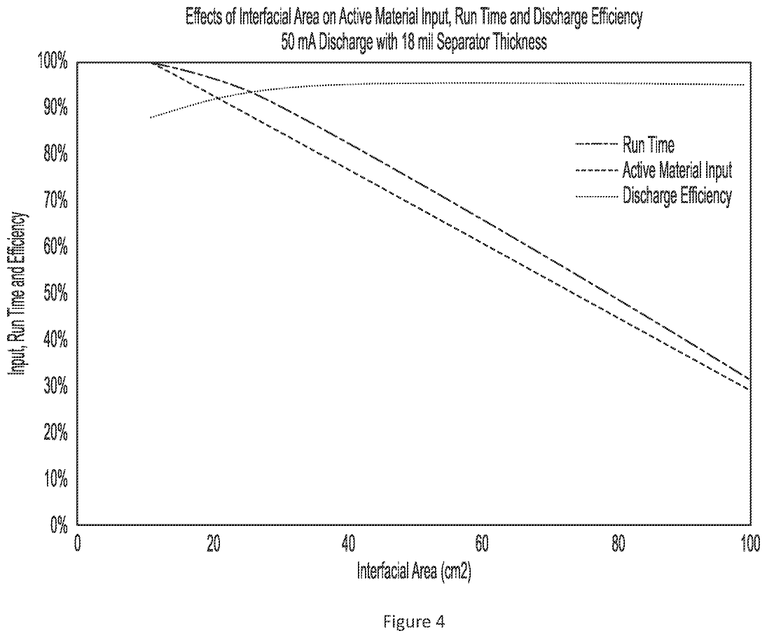

The cell cover can be metal. Nickel plated steel may be used, but a stainless steel is often desirable, especially when the closure and cover are in electrical contact with the cathode. The complexity of the cover shape will also be a factor in material selection. The cell cover may have a simple shape, such as a thick, flat disk, or it may have a more complex shape, such as the cover shown in FIG. 1. When the cover has a complex shape like that in FIG. 4, a type 304 soft annealed stainless steel with ASTM 8-9 grain size may be used to provide the desired corrosion resistance and ease of metal forming. Formed covers may also be plated, with nickel for example, or made from stainless steel or other known metals and their alloys.

The terminal cover should have good resistance to corrosion by water in the ambient environment or other corrosives commonly encountered in battery manufacture and use, good electrical conductivity and, when visible on consumer batteries, an attractive appearance. Terminal covers are often made from nickel plated cold rolled steel or steel that is nickel plated after the covers are formed. Where terminals are located over pressure relief vents, the terminal covers generally have one or more holes to facilitate cell venting.

The gasket used to perfect the seal between the can and the closure/terminal cover may be made from any suitable thermoplastic material that provides the desired sealing properties. Material selection is based in part on the electrolyte composition. Examples of suitable materials include polypropylene, polyphenylene sulfide, tetrafluoride-perfluoroalkyl vinyl ether copolymer, polybutylene terephthalate and combinations thereof. Preferred gasket materials include polypropylene (e.g., PRO-FAX® 6524 from Basell Polyolefins in Wilmington, Del., USA) and polyphenylene sulfide (e.g., XTEL™ XE3035 or XE5030 from Chevron Phillips in The Woodlands, Tex., USA). Small amounts of other polymers, reinforcing inorganic fillers and/or organic compounds may also be added to the base resin of the gasket. Examples of suitable materials can be found in U.S. Patent Publication Nos. 20080226982 and 20050079404, which are incorporated by reference.

The gasket may be coated with a sealant to provide the best seal. Ethylene propylene diene terpolymer (EPDM) is a suitable sealant material, but other suitable materials can be used.

The anode includes a mixture of one or more active materials, an electrically conductive material, optionally solid zinc oxide, and a surfactant. The negative electrode can optionally include other additives, for example a binder or a gelling agent, and the like. Zinc is an example main active material for the negative electrode of the embodiments. Preferably, the volume of active material utilized in the negative electrode is sufficient to maintain a desired particle-to-particle contact and a desired anode to cathode (A:C) ratio. In some embodiments, the anode may comprise micron-scale Zinc particles suspended in a gelled electrolyte of concentrated potassium hydroxide (KOH) in water.

Particle-to-particle contact should be maintained during the useful life of the battery. If the volume of active material in the negative electrode is too low, the cell's voltage may suddenly drop to an unacceptably low value when the cell is powering a device. The voltage drop is believed to be caused by a loss of continuity in the conductive matrix of the negative electrode. The conductive matrix can be formed from undischarged active material particles, conductive electrochemically formed oxides, or a combination thereof. A voltage drop can occur after oxide has started to form, but before a sufficient network is built to bridge between all active material particles present.

Zinc suitable for use in the embodiments may be purchased from a number of different commercial sources under various designations, such as BIA 100, BIA 115. Umicore S. A., Brussels, Belgium is an example of a zinc supplier. In a preferred embodiment, the zinc powder generally has 25 to 40 percent fines less than 75 μm, and preferably 28 to 38 percent fines less than 75 μm. Generally lower percentages of fines will not allow desired DSC service to be realized and utilizing a higher percentage of fines can lead to increased gassing. A correct zinc alloy is needed in order to reduce negative electrode gassing in cells and to maintain test service results.

A surfactant that is either a nonionic or anionic surfactant, or a combination thereof is usually present in the anode. It has been found that anode resistance is increased during discharge by the addition of solid zinc oxide alone, but is mitigated by the addition of the surfactant. The addition of the surfactant increases the surface charge density of the solid zinc oxide and lowers anode resistance as indicated above.

As in the cell in FIG. 1, a separate current collector (i.e., an electrically conductive member, such as a metal foil, on which the anode is coated, or an electrically conductive strip running along substantial portions the length of the anode such that the collector would be spirally wound within the jellyroll) may be used. If used, an anode current collector comprises copper, aluminum, zinc and/or other appropriate high conductivity metals that are stable when exposed to the other interior components of the cell (e.g., electrolyte).

The electrical connection is maintained between each of the electrodes and the opposing external battery terminals, which are proximate to or integrated with the housing. An electrical lead 36 can consist of a thin metal strip connecting the anode or negative electrode to one of the cell terminals (the can in the embodiment of the LR6 cell shown in FIG. 1). The negative electrode may be provided with a lead prior to winding into a jellyroll configuration. The lead may also be connected via appropriate welds.

The metal strip comprising the lead 36 is often made from nickel or nickel plated steel with sufficiently low resistance (e.g., generally less than 15 mΩ/cm and preferably less than 4.5 mΩ/cm) in order to allow sufficient transfer of electrical current through the lead. Examples of suitable negative electrode lead materials include, but are not limited to, copper, copper alloys, for example copper alloy 7025 (a copper, nickel alloy comprising about 3% nickel, about 0.65% silicon, and about 0.15% magnesium, with the balance being copper and minor impurities); and copper alloy 110; and stainless steel. Lead materials should be chosen so that the composition is stable within the electrochemical cell including the nonaqueous electrolyte.

The cathode is in the form of a strip that may include a current collector and a mixture that includes one or more electrochemically active materials, usually in particulate form. The active material at the alkaline battery cathode may be EMD. EMD is present in an amount generally from about 80 to about 92 weight percent and preferably from about 81 to 85 weight percent based on the total weight of the positive electrode, i.e., manganese dioxide, conductive material, positive electrode electrolyte and additives, including organic additive(s), if present. The cathode can also contain small amounts of one or more additional active materials, depending on the desired cell electrical and discharge characteristics. The additional active cathode material may be any suitable active cathode material. Examples include metal oxides, Bi₂O₃, C₂F, CFₓ, (CF)ₙ, CoS₂, CuO, CuS, FeS, FeCuS₂, MnO₂, Pb₂Bi₂O₅ and S.

The cathode can include other components such as a conductive material, for example graphite, that when mixed with the EMD provides an electrically conductive matrix substantially throughout the positive electrode. Conductive material can be natural, i.e., mined, or synthetic, i.e., manufactured. In one embodiment, the cell includes a positive electrode having an active material or oxide to carbon ratio (O:C ratio) that ranges from about 12 to about 24. In an embodiment, the O:C ratio ranges from about 12-14. Too high of an oxide to carbon ratio increases the container to cathode resistance, which affects the overall cell resistance and can have a detrimental effect on high-rate discharge performance, which may be evident from the DSC test, and/or may have a detrimental impact on cell uses that are reliant on higher cut-off voltages (e.g., cut-off voltages above 1.05V). Furthermore, the graphite can be expanded or non-expanded. Suppliers of graphite for use in alkaline batteries include Superior Graphite Company of Chicago, Ill.; and Lonza, Ltd. of Basel, Switzerland. Conductive material is present generally in an amount from about 5 to about 10 weight percent based on the total weight of the positive electrode. Too much graphite can reduce EMD input, and thus cell capacity; too little graphite can increase current collector to cathode contact resistance and/or bulk cathode resistance. Other additives, such as barium sulfate (BaSO₄), barium acetate, titanium dioxide, binders such as coathylene, and calcium stearate, nickelate materials (as described in U.S. patent application Ser. No. 17/032,496, the subject matter of which is incorporated herein by reference in its entirety), and/or other additives may be utilized based on specific electrochemical cell chemistries utilized. Moreover, certain additives may be provided to facilitate manufacturing of a cathode suitable for inclusion in a jellyroll style electrode. For example, additives that enable the cathode material to be extruded, spread, coated, or otherwise provided onto a cathode current collector and then rolled into a jellyroll shape without breakage may be mixed with the cathode material in certain embodiments.

In one embodiment, a positive electrode component (EMD), conductive material, and optionally additive(s) are mixed together to form a homogeneous mixture. During the mixing process, an alkaline electrolyte solution, such as a KOH solution, optionally including organic additive(s), is evenly dispersed into the mixture thereby insuring a uniform distribution of the solution throughout the positive electrode materials.

The cathode mixture may be coated onto one or both sides of a thin metal strip or mesh or expanded or perforated (typically nickel with a thickness between about 16 and about 20 μm), which serves as the cathode current collector. Nickel is a commonly used material, although steel and other metallic foils and alloys thereof are also possible. The current collector may extend beyond the portion of the cathode containing the cathode mixture. This extending portion of the current collector can provide a convenient area for contacting the electrical lead connected to the positive terminal, preferably via a spring or pressure contact that obviates the need for a lead and/or welded contacts. It is desirable to keep the volume of the extending portion of the current collector to a minimum to make as much of the internal volume of the cell available for active materials and electrolyte.

The cathode is electrically connected to the positive terminal of the cell. This may be accomplished with an electrical lead, often in the form of a thin metal strip or a spring, as shown in FIG. 1, although welded connections are also possible. If used, this lead can be made from nickel plated stainless steel or other appropriate materials. In the event an optional current limiting device, such as a standard PTC, is utilized as a safety mechanism. A suitable PTC is sold by Tyco Electronics in Menlo Park, Calif., USA. A typical, standard PTC device generally comprises a resistance of approximately 36 mΩ/cm. Other alternatives, including lower resistance devices, are available and may be preferred. Alternative current limiting devices can be found in U.S. Publication Nos. 20070275298 and 20080254343, which are incorporated herein by reference in their entirety.

The separator is provided to separate the cathode and the anode. The separator maintains a physical dielectric separation of the positive electrode's electrochemically active material from the electrochemically active material of the negative electrode and allows for transport of ions between the electrode materials. In addition, the separator acts as a wicking medium for the electrolyte and as a collar that prevents fragmented portions of the negative electrode from contacting the top of the positive electrode. Separator can be a layered ion permeable, non-woven fibrous fabric. A typical separator usually includes two or more layers of paper.

An electrolyte such as potassium hydroxide (KOH), containing water only in very small quantities as a contaminant (e.g., no more than about 500 parts per million by weight, depending on the electrolyte salt being used), is used in the battery cell of the invention. The electrolyte may additionally comprise an alkaline metal hydroxide such as potassium hydroxide (KOH), sodium hydroxide (NaOH), or the like, or mixtures thereof. Potassium hydroxide is preferred. The alkaline electrolyte used to form the gelled electrolyte of the negative electrode contains the alkaline metal hydroxide in an amount from about 26 to about 36 weight percent, for example from about 26 to about 32 weight percent, and specifically from about 26 to about 30 weight percent based on the total weight of the alkaline electrolyte. Electrolytes that are less alkaline are preferred, but can lead to rapid electrolyte separation of the anode. Increase of alkaline metal hydroxide concentration creates a more stable anode, but can reduce high-rate service. In some embodiments having solid ZnO designs, the dissolved ZnO concentrations may be increased significantly. The metal ions in the electrolyte can have a concentration of 0.1-60,000 ppm. In alternate embodiments, the electrolyte may be neutral or salt-based, as in a zinc-carbon cell.

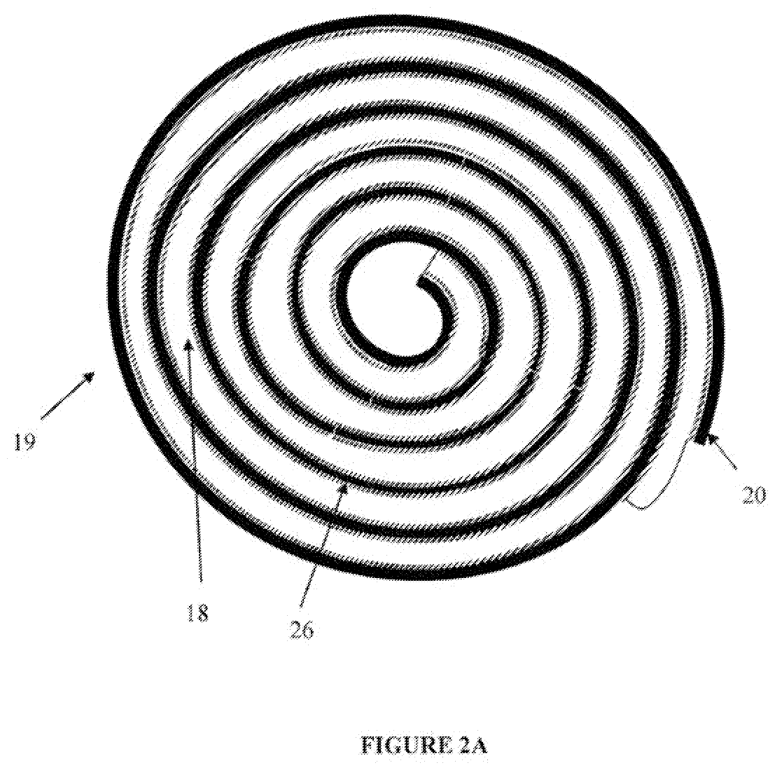

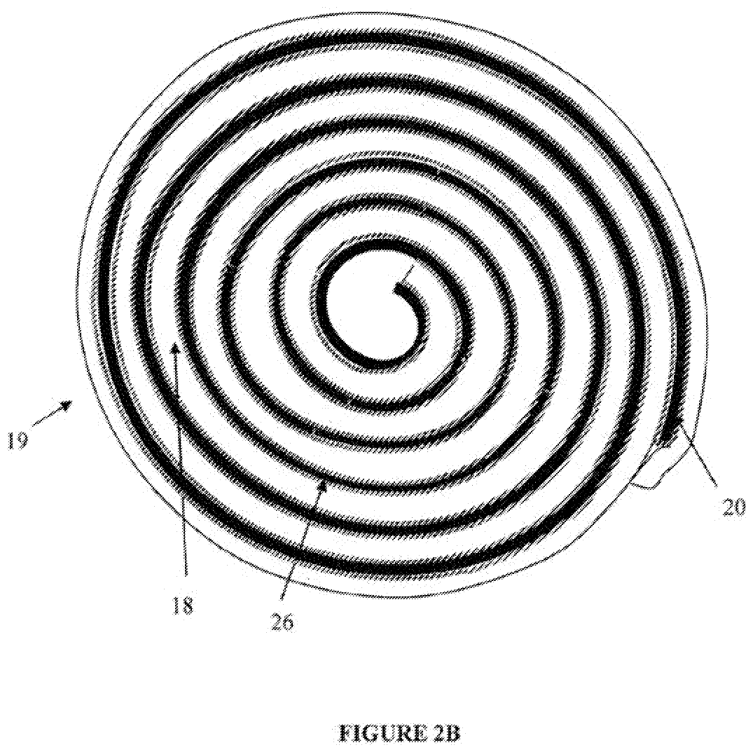

The anode, cathode and separator strips are combined together in an electrode assembly. The electrode assembly may be a spirally wound design, such as that shown in FIG. 1, made by winding alternating strips of cathode, separator, anode and separator around a mandrel, which is extracted from the electrode assembly when winding is complete. At least one layer of separator and/or at least one layer of electrically insulating film is generally wrapped around the outside of the electrode assembly. This serves a number of purposes: it helps hold the assembly together and may be used to adjust the width or diameter of the assembly to the desired dimension. The outermost end of the separator or other outer film layer may be held down with a piece of adhesive tape or by heat sealing. The anode can be the outermost electrode, as shown in FIGS. 1 and 2B, or the cathode can be the outermost electrode as shown in FIG. 2A. Either electrode can be in electrical contact with the cell container, but internal short circuits between the outmost electrode and the side wall of the container can be avoided by matching the polarity of the outermost wind of the electrode assembly to that of the can.

The cell can be closed and sealed using any suitable process. Such processes may include, but are not limited to, crimping, redrawing, collecting and combinations thereof. For example, for the cell in FIG. 1, a bead is formed in the can after the electrodes and insulator cone are inserted, and the gasket and cover assembly (including the cell cover, contact spring and vent bushing) are placed in the open end of the can. The cell is supported at the bead while the gasket and cover assembly are pushed downward against the bead. The diameter of the top of the can above the bead is reduced with a segmented collet to hold the gasket and cover assembly in place in the cell. After electrolyte is dispensed into the cell through the apertures in the vent bushing and cover, a vent ball is inserted into the bushing to seal the aperture in the cell cover. A PTC device and a terminal cover are placed onto the cell over the cell cover, and the top edge of the can is bent inward with a crimping die to hold and retain the gasket, cover assembly, PTC device and terminal cover and complete the sealing of the open end of the can by the gasket.

It is also desirable to use cathode materials with small particle sizes to minimize the risk of puncturing the separator and/or to improve rate performance under certain conditions.

The cathode mixture is applied to the foil collector using any number of suitable processes, such as three roll reverse, comma coating, or slot die coating. A mass-free zone on one or, more preferably, both sides of the cathode current collector can be incorporated into the coating process in order to facilitate electrical connection (either welded or pressure contact) along the top edge of the cathode, which effectively corresponds to a lengthwise uncoated portion along the top edge of each cathode. After or concurrent with drying to remove any unwanted solvents, the resulting cathode strip is densified via calendering or the like to further compact the entire positive electrode. In light of the fact that this strip will then be spirally wound with separator and a similarly (but not necessarily identically) sized anode strip to form a jellyroll electrode assembly, this densification maximizes loading of electrochemical material in the jellyroll electrode assembly.

In a fixed space, such as an LR6 can, the thickness of the electrodes at least partially dictates the amount of interfacial area between the electrodes. Thicker electrodes occupy more space within the fixed interior space of the cell, and consequently fewer winds of the jellyroll can fit within the cell canister. However, the thickness of the separator also influences the number of turns of the jellyroll electrode that can fit within the fixed interior space of the cell canister as well—a thicker separator occupies more space, and as the interfacial area of the electrodes increases (e.g., by decreasing the thickness of the electrodes), the volume of separator material necessary to completely cover the interface surface area proportionally increases, which consequently limits the number of turns of jellyroll that can be inserted into a fixed-size cell canister.

An example of a cathode outer wrap cell design is illustrated in a cross sectional view, i.e., taken along a radius of the jellyroll 19, in FIG. 2A, while FIG. 2B shows an anode outer wrap design. In both of these Figures, the cathode 20 is shown in black and the anode 18 in white with separator 26 illustrated as a broken line. The remaining elements of the cell (as described below) are omitted to better illustrate the difference in design. As used herein, a cathode outer wrap design and cell includes any jellyroll electrode assembly wherein a portion of the surface area on the outermost circumference of active material in the jellyroll is attributable to the cathode (or where less than 50% of the outermost circumference is attributed to the anode). An anode outer wrap cell refers to an electrode assembly with more than 50% of its outermost circumference of active material is attributed to the anode, although in preferred embodiments substantially all of the outer-most active material will be anode. In identifying whether the cell is anode outer wrap or cathode outer wrap, any separator, leads, insulating tape and other inactive component(s) are not considered and the interfacial orientation of the electrodes is not accounted for. Instead, the outermost circumference of the jellyroll is assessed solely on the basis of the outermost portions of anode and cathode that are or would be exposed. Also, as used herein, a lead is considered a separate component as compared to a current collector, insofar as a lead establishes electrical contact between the electrode assembly and the terminal of the battery, while a current collector is used only within the electrode assembly itself (e.g., a current collector conducts electrons to the lead).

In either case (i.e., anode or cathode outer wrap design), the electrodes, and particularly the anode, have a substantially uniform thickness because of its ease of manufacture and the fact that this arrangement maintains the lowest possible internal resistance throughout the discharge of that cell. The cathode coating applied to a single side of the current collector also has a uniform thickness, although intermittent coating techniques may be employed to optimize active material volume and improve cathode utilization.

The foregoing discussion of a jellyroll style electrochemical cell design is provided as an example only. The interfacial area between the anode and cathode can be easily adjusted in a jellyroll configuration by varying the thickness of the anode and cathode electrodes. However, the interfacial area between the anode and cathode can be adjusted with other electrochemical cell structures as well, such as by adjusting the electrode shape of a bobbin-style electrochemical cell structure (e.g., as discussed in U.S. Pat. No. 6,074,781 or U.S. Pat. Publ. No. 2020/0203713, the contents of both of which are incorporated herein by reference in their entirety), a dual anode electrochemical cell structure (e.g., as discussed in U.S. Pat. Publ. No. 2022/0077473; U.S. Pat. No. 5,962,163; or U.S. Pat. No. 5,869,205, the contents of all of which are incorporated herein by reference in their entirety), a central-cathode electrochemical cell structure (e.g., as discussed in U.S. Pat. Publ. No. 2020/0411878, the contents of which are incorporated herein by reference), by alternating disks of anode and cathode materials stacked within a cylindrical battery cell (with intervening separator disks), and/or the like.

### Experimental Results and Optimized Interfacial Area Designs

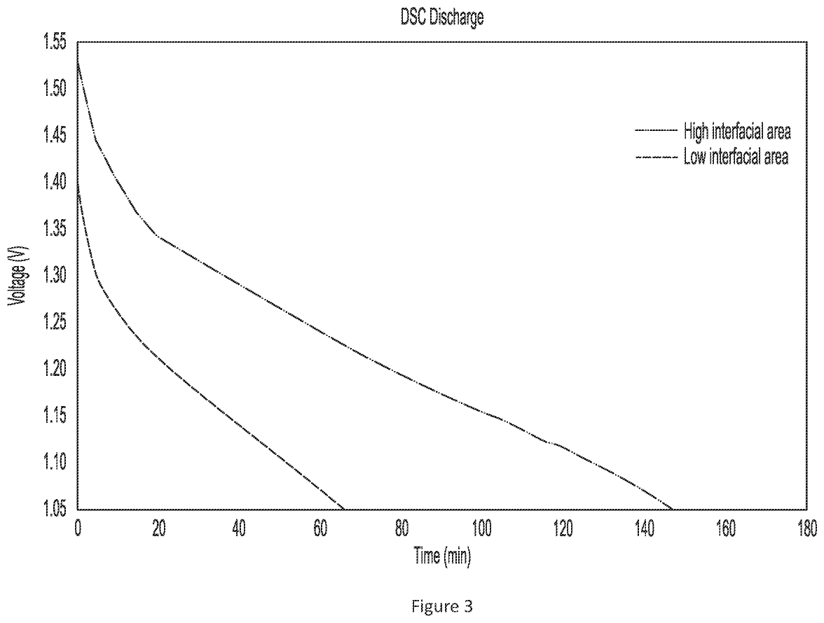

FIG. 3 illustrates a discharge profile for an electrochemical cell in accordance with some embodiments. FIG. 3 illustrates the results of a discharge performance test that was performed with LR6 (AA) Zn—MnO₂ bobbin-style alkaline batteries according to a standard ANSI Digital Still Camera (DSC) testing method. Discharge time is indicated on the x-axis in minutes and voltage is indicated on the y-axis in volts. During the test, the voltage was measured as a function of discharge time for a cell having a high interfacial area and a cell having a low interfacial area. The low interfacial area cell has the standard bobbin cell configuration with a 13 mil separator thickness and about 12 cm² interfacial area. The high interfacial area cell has 3 cylindrical anodes with 13 mil separators and a total 19 cm² interfacial area. Both cells were discharged with the same electrical current/voltage draw. As indicated in FIG. 3, the high interfacial area cell has a discharge time (measured until the cell voltage crosses a lower threshold voltage of 1.05V) of about 148 minutes, while a cell having a low interfacial area has a discharge time of about 65 minutes. By increasing the interfacial area from the low- to high-interfacial area cell reflected in FIG. 3, the cathode (MnO₂) discharge efficiency based on 1 electron discharge of the cathode is increased from 24% to 44% during DSC discharge conditions. Therefore, it is believed that increasing interfacial area between the anode and the cathode is generally desirable for increasing the run time of a cell under high-rate discharge applications (e.g., such as that of the DSC test). As discussed above, high interfacial area designs, however, require higher separator volumes, which decreases the amount of volume within a fixed-size battery cell that can be occupied by active material in the electrochemical cell. This reduction in the amount of active material (cathode and anode) that can be input into the cell can decrease the battery run-time performance for low-rate discharge applications, which are typically characterized by higher discharge efficiency of the active materials.

FIGS. 4-12 illustrate the effect of changing the interfacial area within an alkaline cell for different separator thicknesses. These figures graphically illustrate theoretical experiments for how a change in interfacial area impacts the amount of active material added to the cell, the discharge efficiency of the active material, and the run-time of the cell under different discharge conditions. For run-time and active material input, theses graphs denote percentage changes relative to a control cell—a standard bobbin-type electrochemical cell. For example, a run time of 110% refers to the cell having a run time that is 110% of the runtime of the control cell. Similarly, a cell having 85% of the active material input means that the cell contains 85% as much active material as the control cell. Discharge efficiency is indicated in percentage, and refers to the percentage of cathode active material based on 1 electron EMD capacity that discharges once the cell has reached the designated cut-off voltage (e.g., 1.05V for DSC, 1.0V for 50 mA discharge rate). For example, a discharge efficiency of 95% means that 95% of the active material within the cell has discharged once the cell has reached a designated output voltage. Note that the active material chemistry (i.e., the mixture of anode material within the anode gel, and the mixture of cathode material within the cathode mix) remains the same for all cell designs.

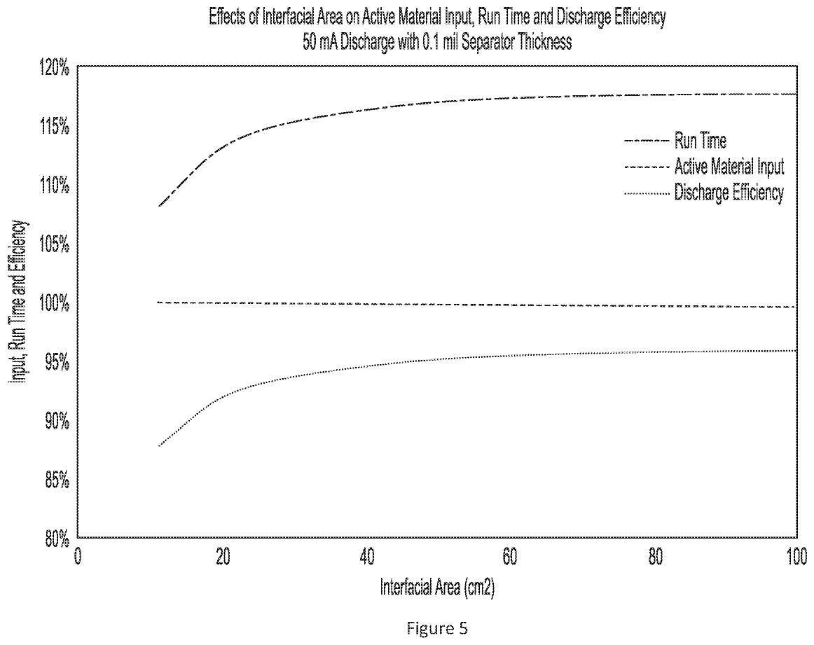

FIGS. 4 and 5 demonstrate the effects of changing the interfacial area within a cell subject to a low rate discharge (50 mA discharge). FIG. 4 illustrates the effects of changing the interfacial area within a cell having a separator having an 18 mil thickness, and FIG. 5 illustrates the effects of changing the interfacial area within a cell having a 0.1 mil separator (a nearly-zero thickness separator). As shown in FIG. 4, for the 18 mil thickness separator, the low-rate discharge ANSI 50 mA discharge run time decreases from 100% to about 31% with an increase in interfacial area from 11 cm² to 100 cm², and the cathode discharge efficiency increases from 88% at 11 cm² interfacial area to 95% at 100 cm². The input reduction with high interfacial area designs as shown in FIG. 4 is due to the separate volume increases when the separator is relatively thick (18 mil in FIG. 4). A thinner separator is believed to have less (potentially negligible) impact on the active material input, and the electrochemical cell performance will increase with an increase in interfacial area. This is shown in FIG. 5, which illustrates the effects of interfacial area on active material input, run time, and discharge efficiency (as in FIG. 4), but with a theoretical separator having 0.1 mil thickness. As shown in FIG. 5, active material input remains at 100% as interfacial area is increased (because the separator has a negligible thickness/volume, even as the interfacial area increases), and run time and discharge efficiency each increase with interfacial area, with run time approaching about 117% and discharge efficiency approaching about 96%.

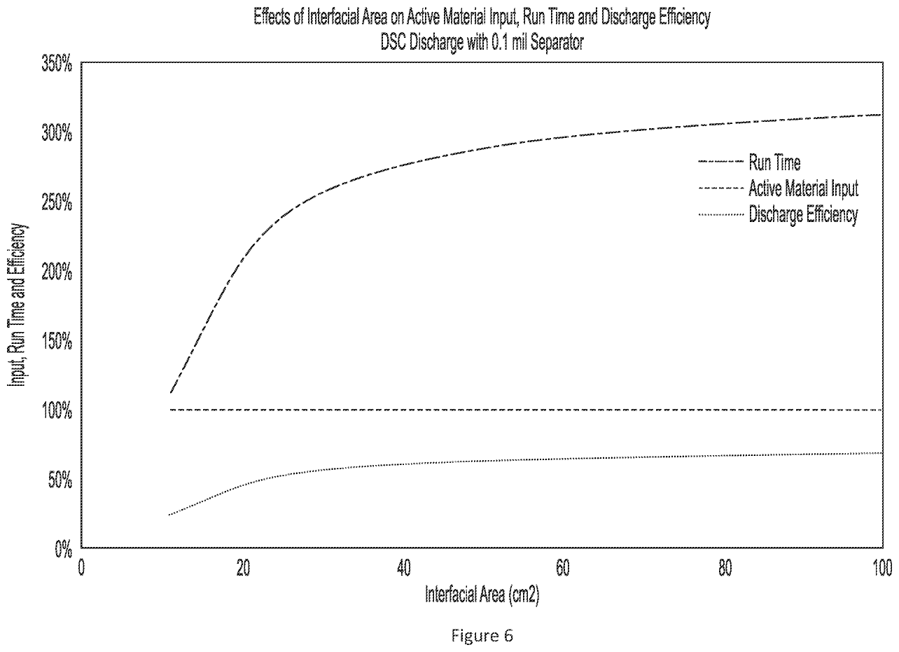

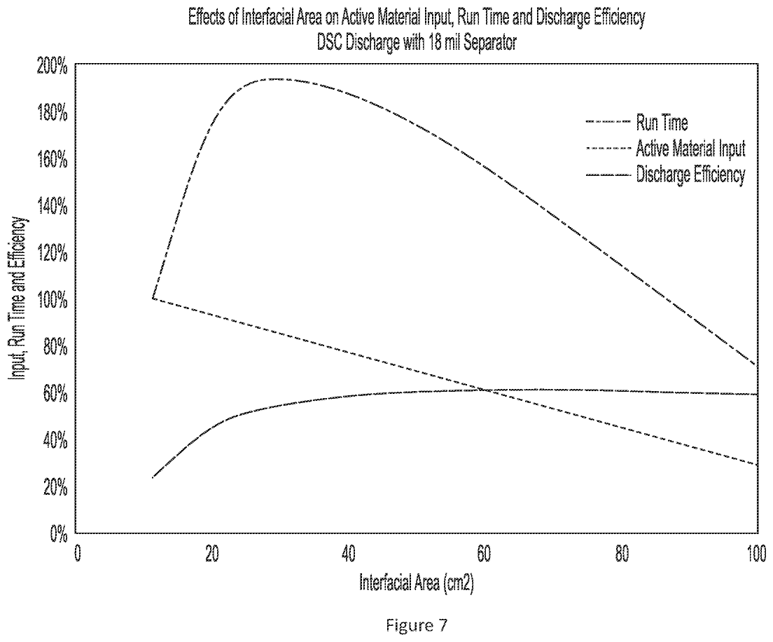

FIGS. 6 and 7 illustrate the effect of changing the interfacial area within a cell subject to high rate discharge (e.g., discharge according to the ANSI-standardized DSC test). FIG. 6 specifically shows the impact of changing the interfacial area within a cell having a negligible-thickness separator (0.1 mil thickness). FIG. 7 illustrates the impact of changing the interfacial area within a cell having an 18-mil thickness separator. In general, electrochemical cells with a high interfacial area are believed to perform better (i.e., having a longer run time and a higher discharge efficiency, even with a lower active material input) under high-rate discharge conditions than under low-rate discharge conditions. Referring now to FIG. 6, which shows the performance of batteries with a 0.1 mil separator when subject to DSC discharge parameters, the run time increases from 113% with 11 cm² interfacial area to 313% with 100 cm² interfacial area, and with corresponding discharge efficiency increase from 25% to 69%. Active material input remains at 100%. Hence, it is believed that decreasing separator thickness (e.g., down to 0.1 mil) and increasing interfacial area may lead to large increases in run time and discharge efficiency, for both high-rate performance devices like the DSC (FIG. 7) and low-rate like 50 mA (FIG. 5).

Referring now to FIG. 7, even when using an 18-mil separator thickness, DSC run time may be increased from 100% at 11 cm² interfacial area to 194% at 30 cm², despite the decrease in active material input. However, the DSC service in FIG. 7 reaches the maximum 194% at 30 cm² interfacial area, after which performance decreases with interfacial area. As with the comparison between FIGS. 6 and 5, the comparison in parameters between FIGS. 7 and 4 seems to indicate high-rate performance has greater relative benefits when compared to low-rate performance. However, FIG. 7 also shows that, with increasing separator thickness (e.g., 18 mil), there is a corresponding decrease in performance (indicated by, for example, run time and active material input) after interfacial area reaches a certain value.

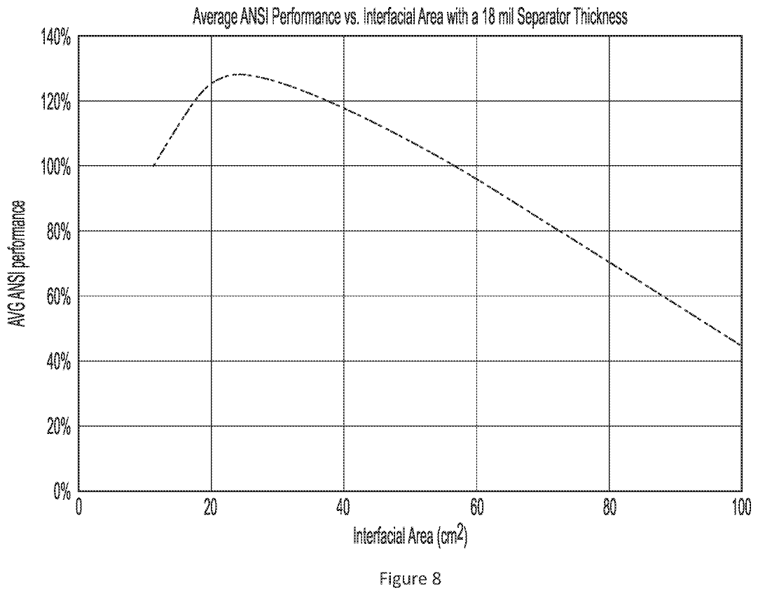

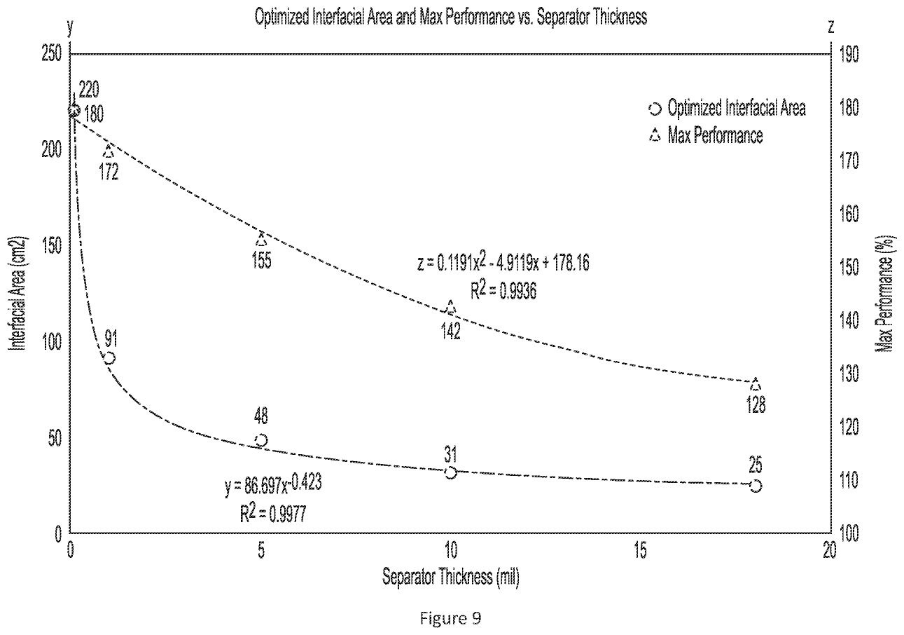

As reflected in FIG. 8, average ANSI performance is charted against interfacial area for an electrochemical cell with an 18 mil separator. The straight average ANSI was calculated for an LR6 size Zn/MnO₂ alkaline battery on 7 ANSI 2021 standard tests; that is, 7 ANSI 2021 standard tests were performed, summed, and divided by 7 to arrive at the calculation. As shown in FIG. 8, performance increases with interfacial area until the optimal point (or “peak performance”) is reached at approximately 25 cm², after which performance declines as interfacial area is increased.

Whereas FIG. 8 graphically illustrates how changes in the interfacial area of an alkaline electrochemical cell impact performance and as noted above, performance reaches a maximum possible performance at an optimized interfacial area. The inventors have found that the optimized interfacial area is dependent on the separator thickness utilized in the cell. FIG. 9 graphically depicts the maximum performance of an alkaline cell (depicted as a performance percentage relative to the control cell) as a function of separator thickness. Maximum performance is charted on the z-axis on the right side of the graph. FIG. 9 also graphically depicts the optimal interfacial area as a function of separator thickness. Interfacial area is charted on the y-axis on the left side of the graph. As mentioned, the maximum possible performance of an alkaline cell is the performance of the alkaline cell having the optimized interfacial area at a given separator thickness. Said differently, in order to obtain the maximum performance possible for a cell having a given separator thickness, the cell should be designed to have the optimal interfacial area.

As reflected in FIG. 9, the maximum performance of a cell can be calculated according to the following equation (1):

$$z = 0.1191 {x}^{2} - 4.9119 x + 178.16 .$$

In equation (1), z is the maximum performance (in percentage of the control cell performance) and x is the separator thickness in mil. FIG. 9 also illustrates that optimized interfacial area decreases as separator thickness increases. The optimized interfacial area can be calculated as follows according to equation (2):

$$y = 86.697 {x}^{- 0.423} .$$

In equation (2), y is interfacial area in cm², and x is the separator thickness in mil.

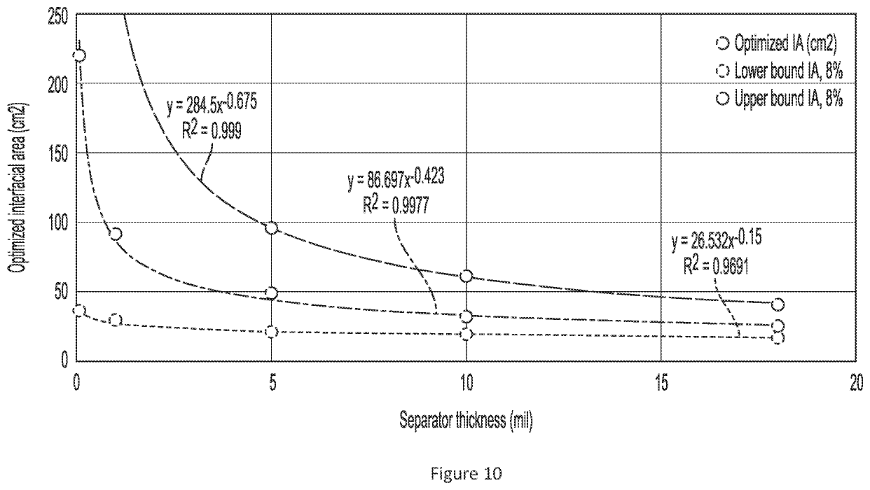

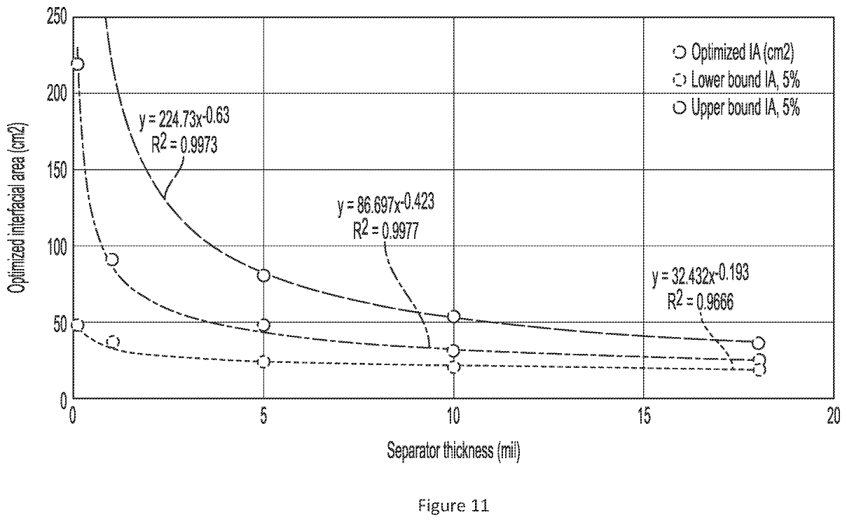

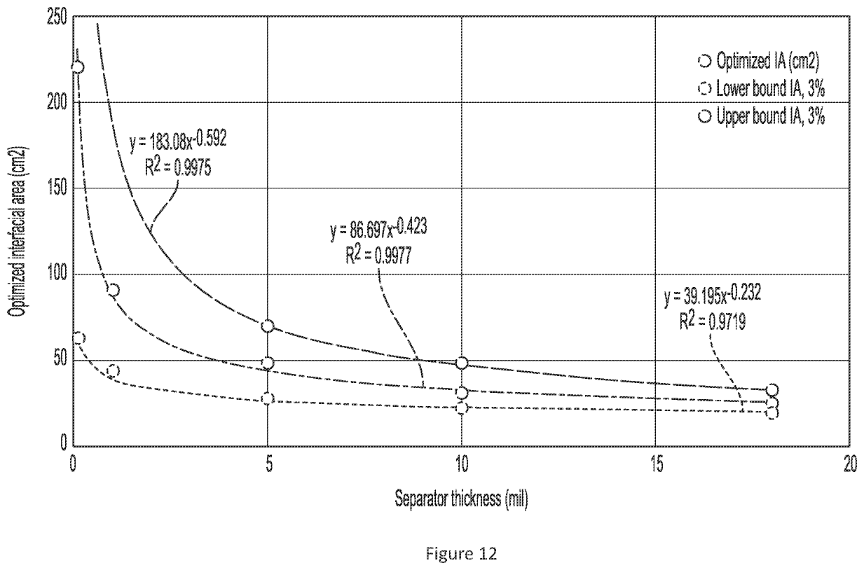

The inventors have found that cells exhibiting performance within 8% of the maximum performance provides acceptable performance while providing adequate manufacturing tolerances to provide a cell having an optimized interfacial area. More preferably, electrochemical cells having a performance within 5% of the maximum performance, and even more preferably, electrochemical cells having a performance within 3% of the maximum performance provides acceptable performance with adequate manufacturing tolerances. FIG. 10 illustrates interfacial areas ranges that may be selected to achieve an alkaline electrochemical cell having performance within 8% of the maximum performance, as a function of separator thickness. FIG. 11 illustrates interfacial area ranges that may be selected to achieve an alkaline electrochemical cell having a performance within 5% of the maximum performance, as a function of separator thickness. FIG. 12 illustrates interfacial area ranges that may be selected to achieve an alkaline electrochemical cell having a performance within 3% of the maximum performance, as a function of separator thickness. As reflected in each of FIGS. 10-12, the interfacial area of the alkaline electrochemical cell may be either above or below the optimal interfacial area while still achieving performance within the respective ranges. Note that values corresponding to these ranges are reflected in Table 1, below. FIG. 10 corresponds to interfacial area range 1 (8% below peak performance), FIG. 11 corresponds to interfacial area range 2 (5% below peak performance), and FIG. 12 corresponds to interfacial area range 3 (3% below peak performance).

Referring now to FIG. 10, alkaline cell performance for an LR6 size cell may be provided to be within 8% of the maximum performance by utilizing an interfacial area within the range of the following equation (3):

$$26.532 {x}^{- 0.15} \leq y \leq 284.5 {x}^{- 0.675} .$$

In equation (3), y is interfacial area in cm², and x is separator thickness in mil. As reflected in Table 1, below, for a cell using a separator having a thickness between 0.1-1 mil, the cell may utilize an interfacial area between 27-1346 cm² to achieve a performance within 8% of the maximum performance of the cell. For a cell using a separator having a thickness between 1-5 mil, the cell may utilize an interfacial area between 21-285 cm² to achieve a performance within 8% of the maximum performance of the cell. For a cell using a separator having a thickness between 5-10 mil, the cell may utilize an interfacial area between 19-96 cm² to achieve a performance within 8% of the maximum performance of the cell. For a cell using a separator having a thickness between 10-18 mil, the cell may utilize an interfacial area between, 17-60 cm² to achieve a performance within 8% of the maximum performance of the cell.

Referring now to FIG. 11, alkaline cell performance for an LR6 size cell may be provided within 5% of the maximum performance by utilizing an interfacial area within the range of the following equation (4):

$$32.432 {x}^{- 0.193} \leq y \leq 224.73 {x}^{- 0.63} .$$

In equation (4), y is interfacial area in cm², and x is separator thickness in mil. As reflected in Table 1, below, for a cell using a separator having a thickness between 0.1-1 mil, the cell may utilize an interfacial area between 32-959 cm² to achieve a performance within 5% of the maximum performance of the cell. For a cell using a separator having a thickness between 1-5 mil, the cell may utilize an interfacial area between 24-225 cm² to achieve a performance within 5% of the maximum performance of the cell. For a cell using a separator having a thickness between 5-10 mil, the cell may utilize an interfacial area between 21-82 cm² to achieve a performance within 5% of the maximum performance of the cell. For a cell using a separator having a thickness between 10-18 mil, the cell may utilize an interfacial area between 19-53 cm² to achieve a performance within 5% of the maximum performance of the cell.

Referring now to FIG. 12, alkaline cell performance for an LR6 size cell may be provided within 3% of the maximum performance by utilizing an interfacial area within the range of the following equation (5):

$$39.195 {x}^{- 0.232} \leq y \leq 183.08 {x}^{- 0.592} .$$

In equation (5), y is interfacial area in cm², and x is separator thickness in mil. As reflected in Table 1, below, for a cell using a separator having a thickness between 0.1-1 mil, the cell may utilize an interfacial area between 39-716 cm² to achieve a performance within 3% of the maximum performance of the cell. For a cell using a separator having a thickness between 1-5 mil, the cell may utilize an interfacial area between 27-183 cm² to achieve a performance within 3% of the maximum performance of the cell. For a cell using a separator having a thickness between 5-10 mil, the cell may utilize an interfacial area between 23-71 cm² to achieve a performance within 3% of the maximum performance of the cell. For a cell using a separator having a thickness between 10-18 mil, the cell may utilize an interfacial area between 20-47 cm² to achieve a performance within 3% of the maximum performance of the cell.

Peak or optimal performance for an alkaline cell may be determined utilizing the optimal interfacial area formula disclosed in FIG. 9 and previously discussed as equation (2). However, it may be difficult and not economically feasible to manufacture cells conforming exactly to this equation. As described previously with respect to FIGS. 10-12 and the equations (3), (4), and (5), performance that is 8%, 5% (preferably), and 3% (more preferably) lower, respectively, has been found to provide improved performance while staying within reasonable manufacturing tolerances. Table 1, as shown and discussed below, details how to create alkaline cells having separator thicknesses and interfacial areas that will achieve performance within the 8%, 5%, or 3% of the peak/optimal performance for an alkaline cell.

Values are provided in the table below (Table 1) for the straight average of ANSI 2021 tests for the previously mentioned LR6/AA Zn—MnO₂ alkaline battery on 7 ANSI standard tests.:

TABLE 1

| | Interfacial | | Interfacial | | Interfacial | |
|---|---|---|---|---|---|---|
| | Area Range | | Area Range 2 | | Area Range | |
| | 1 (8% below | | (5% below | | 3 (3% below | |
| | the peak | | the peak | | the peak | |
| | performance) | | performance) | | performance) | |
| Seperator | Lower | Upper | Lower | Upper | Lower | Upper |
| thickness | bound | bound | bound | bound | bound | bound |
| (mil) | (cm2) | (cm2) | (cm2) | (cm2) | (cm2) | (cm2) |
| 0.1 | 37 | 1346 | 51 | 959 | 67 | 716 |
| 0.2 | 57 | 475 | 44 | 619 | 34 | 843 |
| 0.4 | 48 | 315 | 39 | 400 | 30 | 528 |
| 0.6 | 44 | 248 | 36 | 310 | 29 | 402 |
| 0.8 | 41 | 209 | 34 | 259 | 27 | 331 |
| 1 | 27 | 285 | 32 | 225 | 39 | 183 |
| 2 | 24 | 178 | 28 | 145 | 33 | 121 |
| 3 | 23 | 136 | 26 | 112 | 30 | 96 |
| 4 | 22 | 112 | 25 | 94 | 28 | 81 |
| 5 | 21 | 96 | 24 | 82 | 27 | 71 |
| 6 | 20 | 85 | 23 | 73 | 26 | 63 |
| 7 | 20 | 76 | 22 | 66 | 25 | 58 |
| 8 | 19 | 70 | 22 | 61 | 24 | 53 |
| 9 | 19 | 65 | 21 | 56 | 24 | 50 |
| 10 | 19 | 60 | 21 | 53 | 23 | 47 |
| 11 | 19 | 56 | 20 | 50 | 22 | 44 |
| 12 | 18 | 53 | 20 | 47 | 22 | 42 |
| 13 | 18 | 50 | 20 | 45 | 22 | 40 |
| 14 | 18 | 48 | 19 | 43 | 21 | 38 |
| 15 | 18 | 46 | 19 | 41 | 21 | 37 |
| 16 | 18 | 44 | 19 | 39 | 21 | 35 |
| 17 | 17 | 42 | 19 | 38 | 20 | 34 |
| 18 | 17 | 40 | 19 | 36 | 20 | 33 |

Table 1 displays separator thickness (in mil) on the far left column and the lower and upper bounds of interfacial area (in cm²) in the remaining columns. The separator value in one row corresponds to the lower and upper bounds of interfacial area in the same row. Table 1 is divided into three sections, with the left section showing separator values and interfacial areas for ranges within 8% of peak performance, the middle section showing separator values and interfacial area ranges within 5% of peak performance, and the right section showing separator values and interfacial areas for ranges within 3% of peak performance. For example, for an alkaline cell with 1 mil thickness, to achieve performance within 8% of peak performance, the interfacial area could range from 27 cm² to 285 cm². As another example, for the same cell with 1 mil thickness, to achieve performance within 5% of peak performance, the interfacial area could range from 32 cm² to 225 cm².

According to various embodiments, one or more LR6 alkaline electrochemical cells may be designed based on the above-referenced ratios between the interfacial area of an anode and a cathode and the thickness of a separator. These various electrochemical cells may be based on the “jellyroll” cell discussed previously and shown in FIGS. 1, 2A, 2B. However, it should be understood that other cell constructions may be utilized while complying with the interfacial area to separator thicknesses mentioned above.

In some embodiments, an LR6 alkaline electrochemical cell may include a container; an electrolyte; an anode; a cathode; a current collector; and a separator disposed between the anode and the cathode, wherein the separator may have a thickness of x and wherein an interfacial area of the cathode and the anode may be y, and wherein the relation between the thickness of the separator and the interfacial area of the anode and the cathode may be defined according to the interfacial area range as discussed in reference to FIG. 10, FIG. 11, or FIG. 12.

In some embodiments, an LR6 alkaline electrochemical cell may include a container; an electrolyte; an anode; a cathode; a current collector; and a separator disposed between the anode and the cathode, wherein the separator may have a thickness ranging between a first group of separator thicknesses 0.1-1 mil and having an interfacial area between 27-1346 cm² such that the cell has a performance within 8% of a maximum performance attainable for the cell; an interfacial area between 32-959 cm² such that the cell has a performance within 5% of the maximum performance, or an interfacial area between 39-716 cm² such that the cell has a performance within 3% of the maximum performance. In other embodiments, the separator may have a thickness ranging between a second group of separator thicknesses 1-5 mil and having an interfacial area between 21-285 cm² such that the cell has a performance within 8% of a maximum performance; an interfacial area between 24-225 cm² such that the cell has a performance within 5% of a maximum performance; or an interfacial area between 27-183 cm² such that the cell has a performance within 3% of the maximum performance. In further embodiments, the separator may have a thickness ranging between a third group of separator thicknesses 5-10 mil and having an interfacial area between 19-96 cm² such that the cell has a performance within 8% of a maximum performance; an interfacial area between 21-82 cm² such that the cell has a performance within 5% of a maximum performance; or an interfacial area between 23-71 cm² such that the cell has a performance within 3% of a maximum performance. In still further embodiments, the separator may have a thickness ranging between a fourth group of separator thicknesses 10-18 mil and having an interfacial area between 17-60 cm² such that the cell has a performance within 8% of a maximum performance; an interfacial area between 19-53 cm² such that the cell has a performance within 5% of a maximum performance; and 20-47 cm² such that the cell has a performance within 3% of a maximum performance.

In some embodiments, an LR6 alkaline electrochemical cell may include a container; an electrolyte; an anode; a cathode; a current collector; and a separator disposed between the anode and the cathode, wherein the anode and the cathode define an interfacial area, wherein the interfacial area is selected such that the electrochemical cell has an average ANSI performance within 8% of a maximum theoretical performance of the electrochemical cell, wherein the maximum theoretical performance is achieved by a theoretical electrochemical cell having an interfacial area defined according to the equation discussed in reference to FIG. 9. In some embodiments, the electrochemical cell may have an average ANSI performance within 5% of the maximum theoretical performance of the electrochemical cell. In some embodiments, the electrochemical cell may have an average ANSI performance within 3% of the maximum theoretical performance of the electrochemical cell.

All of the references cited above, as well as all references cited herein, are incorporated herein by reference in their entireties.

While embodiments have been illustrated and described in detail above, such illustration and description are to be considered illustrative or exemplary and not restrictive. It will be understood that changes and modifications may be made by those of ordinary skill within the scope and spirit of the following claims. Embodiments include any combination of features from different embodiments described above and below.

The embodiments are additionally described by way of the following illustrative non-limiting examples that provide a better understanding of the embodiments and of its many advantages. The following examples are included to demonstrate preferred embodiments. It should be appreciated by those of skill in the art that the techniques disclosed in the examples which follow represent techniques used in the embodiments to function well in the practice of the embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the embodiments.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

What is claimed is:

1. An electrochemical cell comprising:
a container;
an electrolyte;
an anode;
a cathode;
a current collector; and
a separator disposed between the anode and the cathode,
wherein the anode and the cathode define an interfacial area y and the separator defines a thickness x, and
wherein a relation between the interfacial area y and the separator thickness x is defined between 26.532x^{-0.15}≤y≤284.5x^{-0.675}.

2. The electrochemical cell of claim 1, wherein the relation between the interfacial area y and the separator thickness x is defined between 32.432x^{-0.193}≤y≤224.73x^{-0.63}.

3. The electrochemical cell of claim 1, wherein the relation between the interfacial area y and the separator thickness x is defined between 39.195x^{-0.232}≤y≤183.08x^{-0.592}.

4. An electrochemical cell comprising:
a container;
an electrolyte;
an anode;
a cathode;
a current collector; and
a separator disposed between the anode and the cathode,
wherein the anode and the cathode define an interfacial area and the separator defines a thickness, and
wherein the separator thickness is selected from a either a first group ranging between 0.1 mil and 1 mil, a second group ranging between 1 mil and 5 mil, a third group ranging between 5 mil and 10 mil, and a fourth group ranging between 10 mil and 18 mil.

5. The electrochemical cell of claim 4, wherein the separator thickness is selected from the first group ranging between 0.1 mil and 1 mil, and the interfacial area is selected from a group ranging between 27 and 1346 cm².

6. The electrochemical cell of claim 5, wherein the separator thickness is selected from the first group ranging between 0.1 mil and 1 mil, and the interfacial area is selected from a group ranging between 32 and 959 cm².

7. The electrochemical cell of claim 6, wherein the separator thickness is selected from the first group ranging between 0.1 mil and 1 mil, and the interfacial area is selected from a group ranging between 39 and 716 cm².

8. The electrochemical cell of claim 4, wherein the separator thickness is selected from the second group ranging between 1 mil and 5 mil, and the interfacial area is selected from a group ranging between 21 and 285 cm².

9. The electrochemical cell of claim 8, wherein the separator thickness is selected from the second group ranging between 1 mil and 5 mil, and the interfacial area is selected from a group ranging between 24 and 225 cm².

10. The electrochemical cell of claim 9, wherein the separator thickness is selected from the second group ranging between 1 mil and 5 mil, and the interfacial area is selected from a group ranging between 27 and 183 cm².

11. The electrochemical cell of claim 4, wherein the separator thickness is selected from the third group ranging between 5 mil and 10 mil, and the interfacial area is selected from a group ranging between 19 and 96 cm².

12. The electrochemical cell of claim 11, wherein the separator thickness is selected from the third group ranging between 5 mil and 10 mil, and the interfacial area is selected from a group ranging between 21 and 82 cm².

13. The electrochemical cell of claim 12, wherein the separator thickness is selected from the third group ranging between 5 mil and 10 mil, and the interfacial area is selected from a group ranging between 23 and 71 cm².

14. The electrochemical cell of claim 4, wherein the separator thickness is selected from the fourth group ranging between 10 mil and 18 mil, and the interfacial area is selected from a group ranging between 17 and 60 cm².

15. The electrochemical cell of claim 14, wherein the separator thickness is selected from the fourth group ranging between 10 mil and 18 mil, and the interfacial area is selected from a group ranging between 19 and 53 cm².

16. The electrochemical cell of claim 15, wherein the separator thickness is selected from the fourth group ranging between 10 mil and 18 mil, and the interfacial area is selected from a group ranging between 20 and 47 cm².

17. An electrochemical cell comprising:
a container;
an electrolyte;
an anode;
a cathode;
a current collector; and
a separator disposed between the anode and the cathode,
wherein the anode and the cathode define an interfacial area,
wherein the interfacial area is selected such that the electrochemical cell has an average ANSI performance within 8% of a maximum theoretical performance of the electrochemical cell, wherein the maximum theoretical performance defined by z=0.1191x²−4.9119x+178.16 is achieved by a theoretical electrochemical cell having an interfacial area defined according to the formula y=86.697x^{-0.423}.

18. The electrochemical cell of claim 17, wherein the electrochemical cell has an average ANSI performance within 5% of the maximum theoretical performance of the electrochemical cell.

19. The electrochemical cell of claim 18, wherein the electrochemical cell has an average ANSI performance within 3% of the maximum theoretical performance of the electrochemical cell.
